(19) United States
(12) Patent Application Publication
(10) Pub. No.: US 2010/0246180 A1
(43) Pub. Date: Sep. 30, 2010

(54) Solid state architectural lighting system

(75) Inventors: Richard D. Ashoff, Newport Beach, CA (US); James R. Zarian, Corona del Mar, CA (US)

Correspondence Address: James R. Zarian, 2707 Blue Water Dr., Corona del Mar, CA, 92625, US

(73) Assignee: Richard d. Ashoff

(21) Appl. No.: 12/662,052

(22) Filed: Mar. 30, 2010

Related U.S. Application Data
(60) Provisional application No. 61/202,708, filed on Mar. 30, 2009.

(51) Int. Cl. F21S 4/00

(52) U.S. Cl. 362/249.02

(57) ABSTRACT

Functional and decorative solid-state lighting systems for architectural applications and method of installation thereof are disclosed. The lighting systems do not require housing or cavity as previously required offering an improved method of installation.

### BACKGROUND

Light emitting diodes have recently been used in many architectural applications. For example, light emitting diodes (LEDs) have been used in cove lighting, emergency lighting and step lighting among others. It is conceived that organic light emitting diodes (OLEDs) can serve the same functions. The use OLEDs; however, has not been as prevalent, most presumably since OLEDs is a more recent technology.

LEDs have mostly been used in applications as point lighting as shown in the pictures below.

Although LEDs and OLEDs offer many advantages such as energy saving, longer life, smaller physical form, contain no dangerous gases among many other advantages in comparison to other lamp technologies such as incandescent, fluorescent, high intensity discharge lamps and the like, it is further believed that additional advantages can be had by using LED, edge-lit panels or light guides (LEP) and/or OLEDs.

Some of the architectural lighting systems such as step lights require a housing and the housing has to be fitted into a space that is carved into the cement, brick, stucco or like walls. This step is requires exact alignment and limits the type of step light or similar systems that can be used.

### FIELD OF THE INVENTION

This invention pertains to illumination and, more particularly, it pertains to LED, edge lit panels or OLEDs in architectural lighting. It is desirable, in architectural applications not to create a carve-out during the construction or later carve out a space to place a housing for a lighting embodiment. The present invention pertains to LED edge lit and/or OLED architectural lighting systems that do not require a carved-out space for placement of the light.

### SUMMARY OF THE INVENTION

The present invention herein provides methods and systems for accomplishing the objects of the present invention using LEP and/or OLEDs, herein after referred to as solid-state lighting or SSL.

In practice, SSL of the present invention has a very narrow profile which allows the lighting system to be installed onto a wall, for example, using a rather small conduit. The conduit serves two purposes, one allows the power to reach the embodiment and second it holds or supports the embodiment installation onto a wall. FIG. 1 shows a schematic of such a system.

When energized, the SSL projects light outwardly onto an area such as pathways, steps and the like.

The SSL can be of numerous colors and can also be solar powered.

Another aspect of the invention provides an illumination method and system that produces a highly decorative effect by color changing.

In yet another preferred embodiment, an OLED can project light uniformly outward onto a surface.

In practice, it has been found that two conduits may provide better support. In such cases, one conduit may be used to provide power and both conduits provide support. In other instances a plurality of conduits may be advantageous and in such instances multiple conduits can be used.

It is understood that through-hole, surface mount and chip-on-board LEDs can readily be used to achieve the objectives of the present invention.

The LED can be under-driven (e.g., by applying less than allowable maximum voltage and/or amperage) to prolong the life of the LED.

These and other details will become apparent from the following description of the preferred embodiment, of which the drawing forms a part.

### DESCRIPTION OF THE DRAWING

FIG. 1 (comprising FIGS. 1a-c), FIG. 1a is a front elevation view of an LED, edge-lit illumination panel assembly constructed in accordance with the invention, FIG. 1b showing view of the assembly along line A-A and FIG. 1c showing side view of the assembly along line B-B;

FIG. 2 is a front elevation view of an LED, edge-lit illumination panel assembly of LED light source used as edge lighting and v-cut planar light guide panel;

FIG. 3 is a front elevation view of an LED, edge-lit illumination panel assembly of LED light source used as edge lighting and dot-printed planar light guide panel;

FIG. 4 is a front elevation view of an LED, edge-lit illumination panel assembly of LED light source used as edge lighting and dot-etched planar light guide panel;

FIG. 5 is a front elevation view of an LED, edge-lit illumination panel assembly of LED light source used as edge lighting and microlenses, microprisms or microstructure planar light guide panel;

FIG. 6 (comprising FIGS. 6a-c), FIG. 6a is a front elevation view of an illumination assembly constructed in accordance with the invention, FIG. 6b is a side elevation view of the assembly along line A-A and FIG. 6c showing side view of the assembly along line B-B; where a series of LED is used as a light source

FIG. 7 (comprising FIGS. 7a-c), FIG. 7a is a front elevation view of an illumination assembly constructed in accordance with the invention, FIG. 7b is a side elevation view of the assembly along line A-A and FIG. 6c showing side view of the assembly along line B-B; where an OLED is used as a light source;

### DESCRIPTION OF THE PREFERRED EMBODIMENT

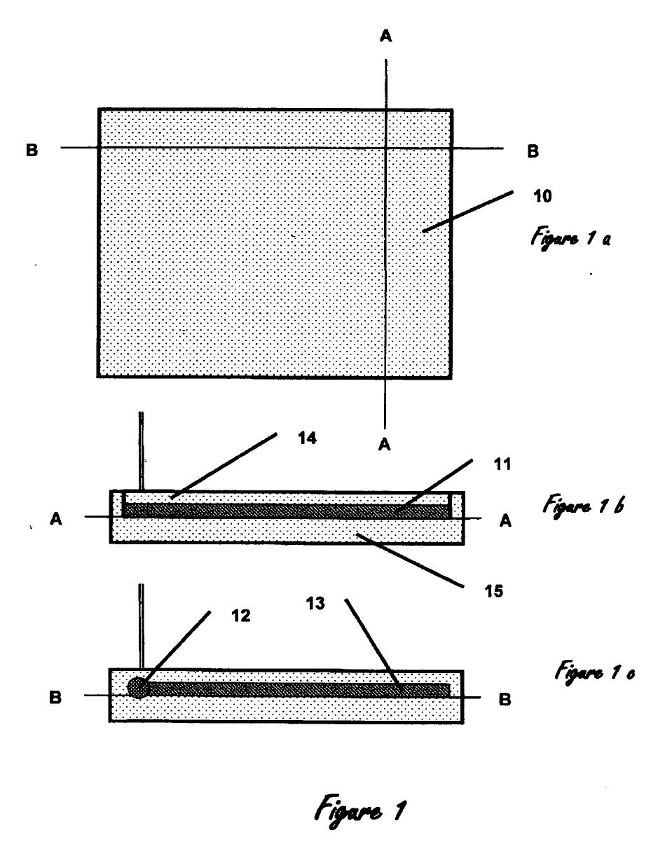

FIG. 1 is a front elevation view of an step light frame or light frame (LF) 10 constructed and useful for applications wherein lighting is to be incorporated in accordance with the invention. The LF 10 is adapted to comprise an LEP 11 mounted within the LF 10.

The LEP 11 has two parts. The light source 12 and planar light guide panel 13. In practice, it is desirable to enclose the illumination assembly within the two sub-assemblies 14 and 15 of the embodiment of the present invention.

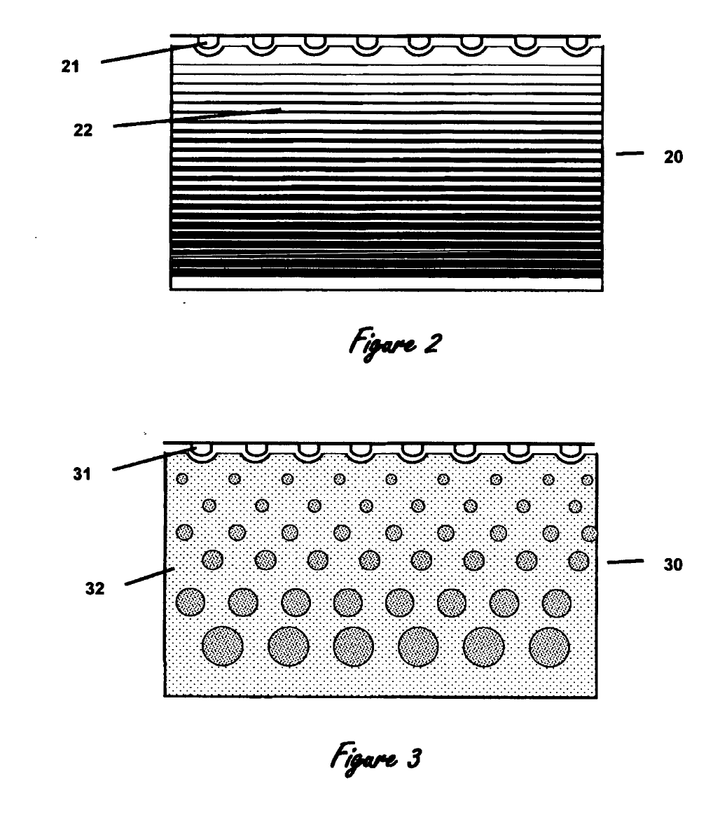

Turning to FIG. 2, a LEP 20 of the present invention is shown where a planar light guide panel is edge-illuminated by LED sub-assembly 21 projecting light into a v-cut planar light guide panel 22 well known in the art. It is understood that the LEP 20 is positioned into an assembly similar to assembly 10 shown in FIG. 1 to provide illumination in accordance with the present invention.

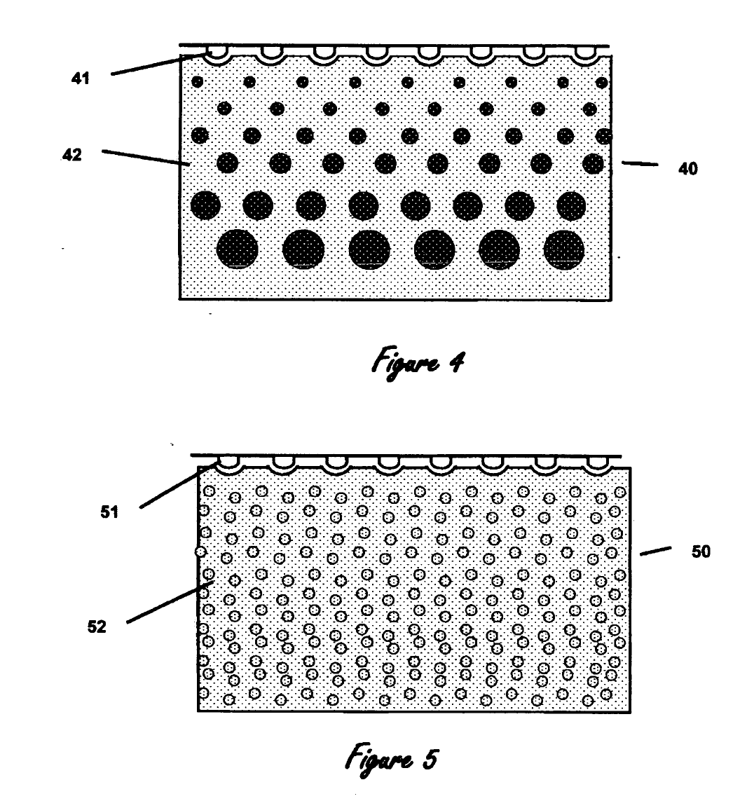

Alternatively turning to FIG. 3, a LEP 30 of the present invention is shown where a LED sub-assembly 31 projects light into a dot-printed planar light guide panel 32 well known in the art. It is understood that the LEP 30 is positioned into an assembly similar to assembly 10 shown in FIG. 1 to provide illumination in accordance with the present invention.

Alternatively turning to FIG. 4, LEP 40 of the present invention is shown where LED sub-assembly 41 projects light into a dot-etched planar light guide panel 42 well known in the art.

It is understood that the LEP 40 is positioned into an assembly similar to assembly 10 shown in FIG. 1 to provide illumination in accordance with the present invention.

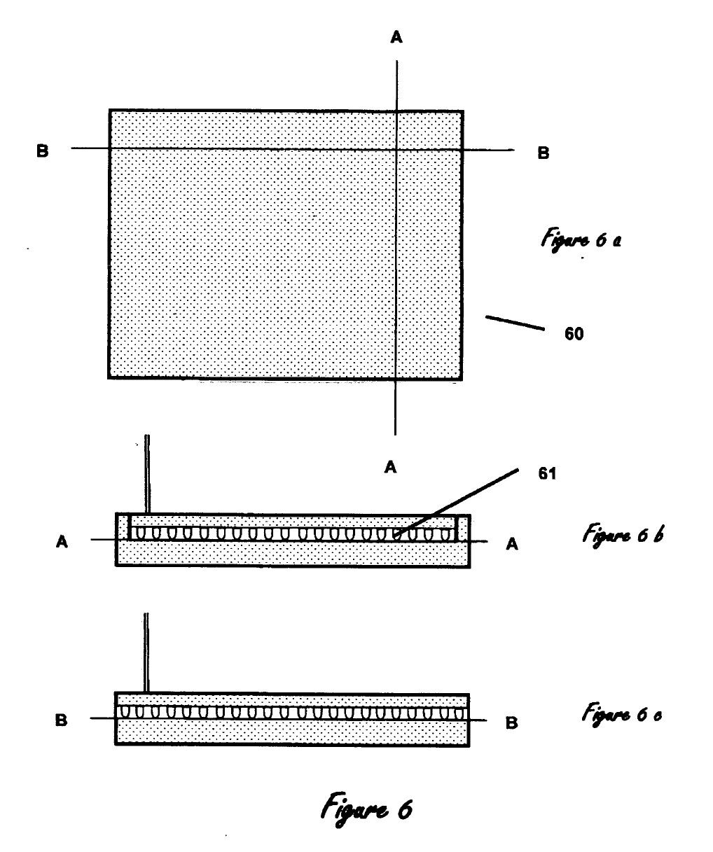

Alternatively turning to FIG. 5, an assembly 50 of the present invention is shown where a LED sub-assembly 51 projects light into a planar light guide panel 52 with microlenses well known in the art. It is understood that the LEP 50 is positioned into an assembly similar to assembly 10 shown in FIG. 1 to provide illumination in accordance with the present invention.

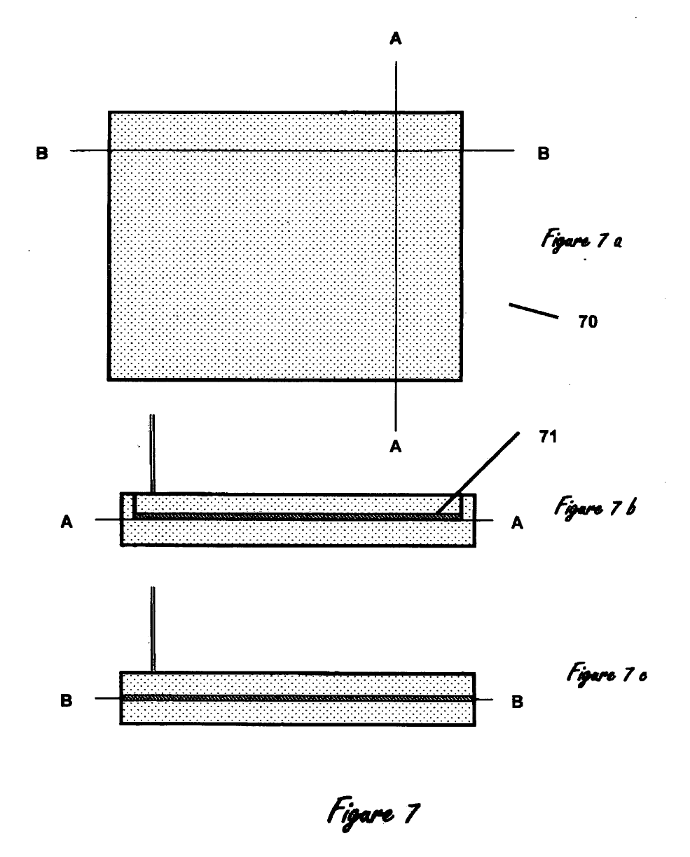

Turning to FIG. 6, an assembly 60 of the present invention is shown where a series of LEDs are assembled to project light evenly into the embodiments of the present invention. It is understood that the LED 61 project light directly, from the backside, onto the embodiment of the present invention. It is understood that the assembly 60 is positioned into an assembly similar to assembly 10 shown in FIG. 1 to provide illumination in accordance with the present invention. In such arrangements, through hole, surface mount and chip on board LEDs can be used, and the chip on board LEDs are the most preferred.

Turning to FIG. 7, an assembly 70 of the present invention is shown where an OLED 71 is shown, the OLED project light evenly into the embodiments of the present invention. It is understood that the assembly 70 is positioned into an assembly similar to assembly 10 shown in FIG. 1 to provide illumination in accordance with the present invention.

We claim the above inventions:

1. A solid-state lighting system, comprising:
at least one enclosed, solid-state lighting as the lighting part;
and at least one conduit part integrally attached to the lighting part.

2. The conduit of claim 1 adapted to be inserted into a surface.
